(19) United States
(12) Patent Application Publication
(10) Pub. No.: US 2003/0079210 A1
(43) Pub. Date: Apr. 24, 2003

(54) Integrated register allocator in a compiler

(76) Inventors: Peter Markstein, Woodside, CA (US); Meng Lee, Cupertino, CA (US)

Correspondence Address: HEWLETT-PACKARD COMPANY, Intellectual Property Administration, P.O. Box 272400, Fort Collins, CO, 80527-2400, US

(21) Appl. No.: 09/982,020

(22) Filed: Oct. 19, 2001

(51) Int. Cl. G06F 9/45

(52) U.S. Cl. 717/152; 717/146

(57) ABSTRACT

A compiler includes a real register allocation stage, an optimization stage and a final code stage. The real register allocation stage is configured to generate intermediate code from a basic block of source code. Physical registers, instead of virtual registers, are allocated to operands from the generated intermediate code, and the operands are stored in the physical registers. Then, the intermediate code is optimized, and machine readable code is generated from the intermediated code using the optimized registers in the final code stage. By allocating physical registers in the front-end of the compiler, instead of just prior to generating the machine-readable code, compiling time and memory needed for compiling source code is reduced.

### FIELD OF THE INVENTION

The present invention is generally related to a software compiler. More particularly, the present invention is related to optimizing compiler speed and space using register allocation techniques.

### BACKGROUND OF THE INVENTION

Typical compilers may include four stages for compiling code. FIG. 5 illustrates four stages (501-504) for compiling code using a conventional compiler 500. In an intermediate register stage 501, the compiler 500 receives source code to be compiled. In the stage 501, intermediate code is generated, and virtual registers are assigned to the intermediate code. For example, the source code is parsed and converted into an intermediate language. The intermediate language is an idealized language that may have an unlimited number of registers (i.e., intermediate registers, also known as virtual registers). The virtual registers are used to temporarily store operands, which are allocated to real registers in a later stage.

In an optimize intermediate code stage 502, the intermediate language code is optimized using conventional techniques (e.g. subexpression optimization, and the like). Optimization of the intermediate code is typically performed to increase the efficiency and/or reduce the size of the final compiled code.

In a register allocation stage 503, a conventional register allocation process is used to convert intermediate registers into real registers. In stage 501, an unlimited number of intermediate registers may be designated. However, only a limited number (e.g., 32 registers, or the like) of real registers (i.e., actual hardware registers supported by the particular platform on which the final code is executed) are available. Therefore, in the stage 503, a register allocation process allocates the intermediate registers to the limited number of real registers, so that computations specified by a set of code instructions, which are in the computer program being compiled by the compiler 500, can be performed in the set of real registers. In a final code stage 504, the final code is generated from the intermediate code. The final code is machine-readable code (e.g., executable, machine code, and the like).

For situations when the number of intermediate registers is less than or equal to the number of real registers, the contents of each of the intermediate registers can be directly assigned to a real register. However, when the number of intermediate registers exceeds the number of real registers, then the set of intermediate registers must be mapped to the set of real registers using conventional register allocation techniques.

For example, when the number of available real registers is insufficient to store all of the intermediate values in the intermediate registers that are specified by the code instructions, some intermediate values may have to be stored in other memory. The process of temporarily storing data from a real register to another memory location is referred to as spilling. Generally, spilling involves performing a store operation, followed by one or more reload operations. A spill operation causes data contained in a real register to be stored in another memory location, such as a runtime stack. Each reload operation causes the data to be loaded or copied from the other memory location into a real register. Reload operations are performed when the data is required for a calculation. A prologue and an epilog may be used to save and restore callee-saved registers (e.g., registers storing operands preserved for an extended period of time during execution of the translated code). A prologue and epilog typically includes code executed before and after a subroutine or program. For example, when a prologue is executed stack space may be allocated for saving necessary context, such as saving callee-saved registers. When an epilog is executed, the compiler may restore any necessary registers.

Conventional register allocation processes are typically quadratic in nature, and the time and space needed to perform a conventional register allocation process may be proportional to the square of the number of intermediate registers generated in step 501. Therefore, the register allocation stage 503 dominates the space and time of the entire compilation. When debugging a program, the program may be compiled a number of times. Accordingly, it is beneficial to minimize compiling time, especially for large programs. For dynamic compiling, it is also beneficial to minimize compiling time. Dynamic compiling includes translating code while a user interacts with a computer performing the translation. Dynamic compilation is used with JAVA and other languages. An extended compilation time may be highly noticeable to a user, especially during dynamic compilation when a user interacts with the computer performing the compilation.

### SUMMARY OF THE INVENTION

An aspect of the invention is to provide a compiler configured to compile source code into machine-readable code. The compiler includes the following stages: a register allocation stage configured to generate intermediate code from source code and allocate a plurality of real registers to a plurality of operands from the intermediate code; an optimization stage configured to optimize the intermediate language code; and a final code stage configured to generate the machine-readable code from the intermediate code using the plurality of real registers.

Another aspect of the invention is to provide a method of allocating registers when compiling source code. The method includes steps of translating source code to intermediate code; identifying an operand from the intermediate code to store in a real register; and selecting an appropriate class of real registers to store the operand.

Another aspect of the present invention is to provide a method of compiling source code including steps of generating intermediate code from a portion of source code; allocating a plurality of real registers to store a plurality of operands from the intermediate code; optimizing the resultant intermediate language code; and generating machine-readable code from the intermediate code using the plurality of allocated registers.

The methods of the invention include steps that may be performed by computer-executable instructions executing on a computer-readable medium.

In comparison to known prior art, certain embodiments of the invention are capable of drastically reducing compilation time and space (i.e., memory needed for compiling). Those skilled in the art will appreciate these and other advantages and benefits of various embodiments of the invention upon reading the following detailed description of a preferred embodiment with reference to the below-listed drawings.

### BRIEF DESCRIPTION OF THE DRAWINGS

The present invention is illustrated by way of example and not limitation in the accompanying figures in which like numeral references refer to like elements, and wherein:

FIG. 1 illustrates a block diagram of an embodiment of an exemplary compiler of the invention;

FIG. 2 illustrates a flow diagram of an embodiment an exemplary compilation method performed by a compiler of the invention;

FIG. 3 illustrates an embodiment of an exemplary register allocator employing principles of the invention;

FIG. 4 illustrates an embodiment of an exemplary computing system which utilizes the invention; and

FIG. 5 illustrates a block diagram of a conventional compiler.

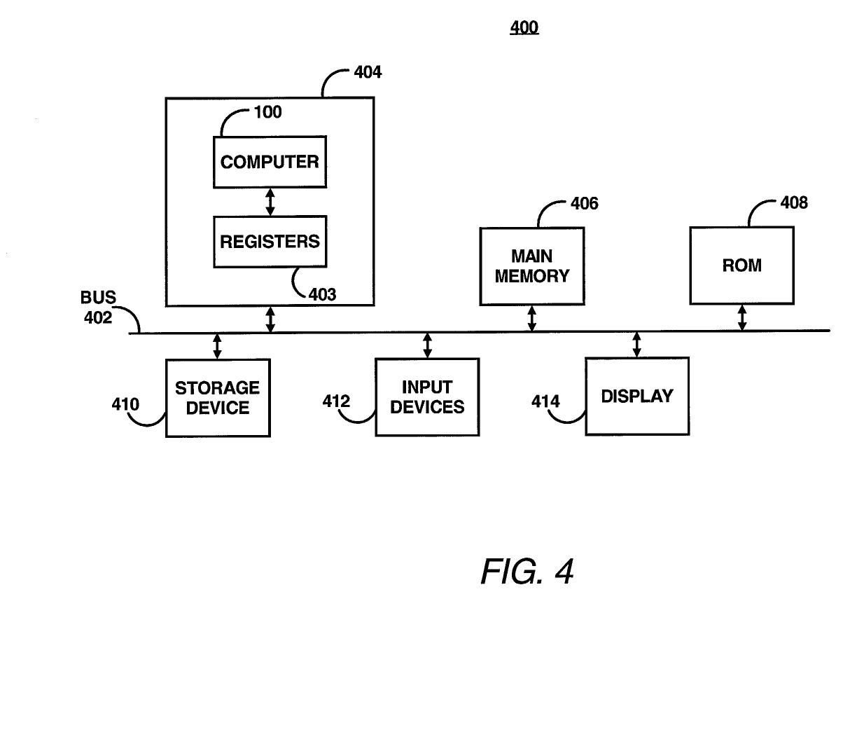

### DETAILED DESCRIPTION OF THE INVENTION

In the following detailed description, numerous specific details are set forth in order to provide a thorough understanding of the present invention. However, it will be apparent to one of ordinary skill in the art that these specific details need not be used to practice the present invention. In other instances, well known structures, interfaces, and processes have not been shown in detail in order not to unnecessarily obscure the present invention.

An embodiment of the invention abandons the industry standard practice of using virtual registers in front and middle stages of a compiler, and then allocating the virtual registers to real registers in the back-end of the compiler. Instead, real registers are assigned in the front stage and optimization stages of a compiler, thereby eliminating the register allocation stage of a conventional compiler.

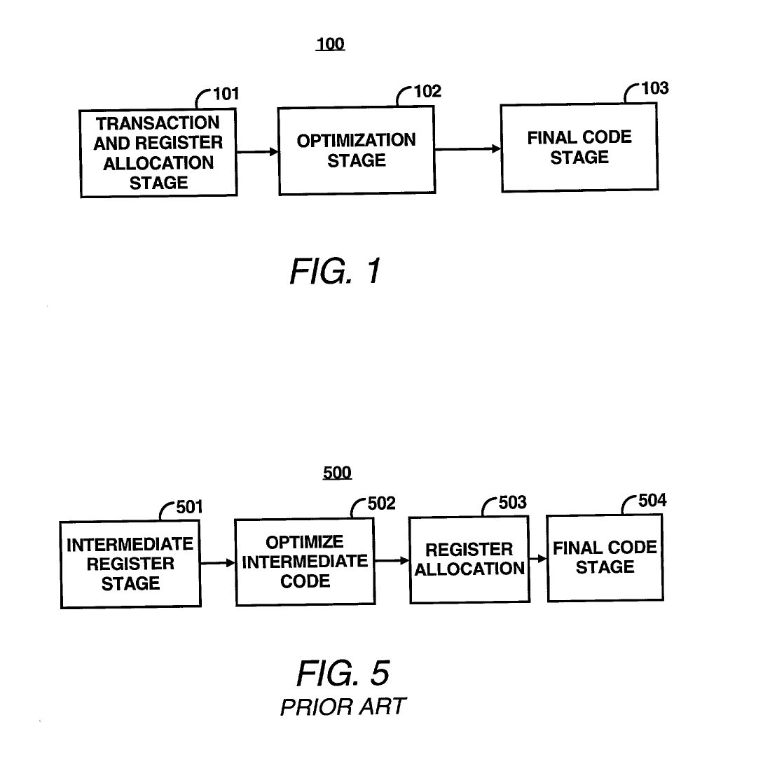

FIG. 1 illustrates an exemplary embodiment of a compiler 100 employing principles of the invention. The compiler 100 includes stages 101-103. In a translation and register allocation stage 101, the compiler 100 receives source code to be compiled, converts it into intermediate language and performs register allocation. During register allocation, information, such as operands from the intermediate language code, is assigned to real registers rather than intermediate registers. In an optimization stage 102, the intermediate language code is optimized, for example, using conventional optimization techniques. In a final code stage 103, the final code (e.g., machine-readable code) is generated from the intermediate code and using the previously allocated real registers.

An exemplary embodiment of the compiler 100 may be a Java JIT compiler. However, it will be apparent to one of ordinary skill in that the compiler 100 may be used for compiling other computer languages as well.

In a Java JIT compiler, the compiler 100 preferably allocates three types of quantities to real registers. The three types include stack items, local variables including parameters input by a user, and temporary computations.

Stack items include items stored on a stack that may need to be readily available. Stack items arise when the source language or intermediate language is in terms of a stack machine. In a stack machine, intermediate values may be pushed onto and popped from a stack, and other operations may imply taking operands from the top of the stack and replacing them with the result of the operation. When the target machine is a register-based machine, it is preferable to keep such quantities in registers if a sufficient number of registers are available.

Local variables and parameters correspond directly to objects in the source code. Temporary computations are computations whose results are used relatively quickly by the program and which do not explicitly correspond to variables or quantities in the original source code. For example, the address of an indexed array element may be the result of a temporary computation which multiplies an index by four and adds the product to the base address of the array. Information not allocated to registers may be stored in memory, but may take longer to retrieve and increase execution time of the compiled code.

The real registers used by the compiler 100 may include more than one type of register. For example, the real registers may be divided into integer registers (e.g., storing integer values) and floating point registers (e.g., storing floating point values). It will be apparent to one of ordinary skill in the art that only one type of real registers may exist (e.g., some processors may only include integer registers) or more than two types of real registers may be used by a particular processor. Also, register types may include Boolean, two's complement, one's complement, and the like. User defined types may also be used.

In addition to different types of real registers, different classes of real registers may also be used. Different classes of real registers may include caller-saved registers and callee-saved registers. Callee-saved registers are preferably used to store local variables and stack items (since these values will be preserved over an extended period of time during the execution of the translated code). Caller-saved registers are preferably used to store temporary computations, except for those which are known to be live over any method calls. Heuristic techniques may be used to determine which values are stored in callee-saved registers and which values are stored in caller-saved registers. For example, the compiler 100 may store temporary computations in the caller-saved registers, because the temporary computations are needed for a limited period of time. A program may be compiled such that a library routine may store a temporary computation in a caller-saved register. Local variables and stack items, which are generally needed for a longer period of time, are stored in callee-saved registers.

In addition to being divided into classes (e.g., caller-saved and callee-saved registers), the real registers may be marked as having particular properties, such that the registers are included in one or more subclasses, depending on the type of data being stored in the register. In the exemplary embodiment, registers may be classified into the following subclasses based on their properties: live, busy, available, used, and used-in-current-operation subclasses. These subclasses are defined as follows:

1. available registers are those registers which are part of a class (e.g., caller_saved registers and callee_saved registers, as previously discussed).

2. used registers are those registers which have been modified at any time during the compilation process.

3. used-in-current-operation registers are those registers which hold values for the operation currently being constructed. They may not be reallocated or spilled.

4. busy registers are registers which hold information known to be used at a later time. If these must be reallocated, their contents must be preserved in memory. The used-in-current-operation registers are a subset of the busy registers.

5. live registers are registers which hold known, valid quantities, but are no longer required for the intermediate code sequence being generated. After the last use of a busy register, the busy register becomes a member of the live set (such as for possible later re-use).

Bit vectors may be used for keeping track of the various properties of these registers. For example, for each property a 32-bit bit vector is used to identify which of thirty-two real registers has the said property. Each bit in each of the 32-bit bit vectors corresponds to a particular register (e.g., the most significant bit corresponds to the first real register, the next bit corresponds to the second register, etc.). Depending on the value of the bit, a different property is set for a register. For example, a 32-bit bit vector may represent the live property. If the most significant bit is “1”, then the first register is live. If the most significant bit is “0”, then the first register is non-live. Together, the multiple 32-bit bit vectors are representative of a table that identifies the properties of each register (i.e., the class and subclass(es) that each register may belong to).

If a target architecture has more than 32 registers, then each property requires several 32-bit vectors. For example, INTEL ITANIUM, with 128 real registers, requires four, 32-bit bit vectors or two, 64-bit bit vectors to represent all the real registers.

A live register may be reallocated at no immediate cost, although it may contain useful data for later operations. If a live register is reallocated and the value of its former contents are required later, then the value may have to be recomputed. Also, the contents of a live register may be spilled (i.e., saved in memory, such as random access memory (RAM) and the like, and then reloaded when needed).

Registers which are busy are less desirable for allocation may be spilled to storage if non-busy registers are not available. A register is marked as busy if the contents of the register are needed in the near future. For example, a block of source code may include the variable C is equal to the variable I multiplied by four. A register may contain the value of the variable I, that was determined by a previous computation. That register having the contents I is marked as busy, because it is needed for the computation of C, performed in the near future.

Registers which are marked as used-in-current operation may not be spilled, because these registers have already been allocated for the instruction that registers are currently being allocated for. For example, a block of source code may include the variable C is equal to the variable I multiplied by J. When allocating registers for this computation, the register storing the value I is marked as used-in-current-operation, so that register may not be used for storing other values, such a the value of J. Therefore, when allocating a register for the value of J, the register storing the value of I will not be allocated.

Registers may be marked as used, for example, for efficient allocation. All callee-saved registers which are used and which are needed for allocation will have to be spilled during the prolog and restored during the epilog. Accordingly, if a callee-saved register is required for allocation and a used, callee-saved register can be found that is not busy, then that register is desirable for allocation because no additional registers need be spilled in the prolog and restored in the epilog. For example, a used, callee-saved register has already been spilled. It is efficient to reallocate that register, because its contents have already been spilled.

The compiler 100 translates basic blocks of code. A basic block does not contain any branches. A basic block ends when a branch or the target of another branch is encountered. A typical if-then statement, for example, may include a first basic block (i.e., the condition being tested) and a second basic block (i.e., the then statement, executed if said condition was true). A basic block may include, for example, a Java bytecode operation, and several intermediate language operations may be generated from the bytecode. For each intermediate-language operation, each operand is analyzed to determine whether it is already stored in a real register. If the operand is stored in a real register, then the register is marked as used-in-current-operation, as well as busy. If the operand is not stored in a real register, a real register is allocated from registers that are not marked as used-in-current-operation.

To allocate a temporary computation, registers from the caller-saved class, rather than the callee-saved class, are preferred, provided it is known that the temporary computation will not be required to hold a value over a call operation. Analysis may include analyzing bit vectors for each register to identify properties of the register. Bit vectors may designate properties including available caller-saved, available callee-saved, busy, used, used-in-current-operation, live, and the like. The preference is to allocate caller-saved registers which are not live, not busy, but used. The next preference includes registers that are not live and not busy. If none of these are available, a live but non-busy register is selected. If a live register is selected, then a map (e.g., a table T) which relates Java computations to real registers is modified to indicate that the Java computation no longer resides in the real register. If no non-busy registers are available, then registers from the callee-saved class may be analyzed using the preferences described above. Registers in the callee-saved class are less likely to be non-busy, because these registers are preferred for allocation of local variables, stack items, parameters, and the like, which have long lifetimes.

If only busy registers are found, a busy register may be selected for allocation from among those registers that are not used in the current operation. The contents of the selected busy register may be spilled. For example, if the selected register holds a local variable or Java stack item, the item must first be saved in memory. If a stack item is spilled, then a memory location is allocated for the stack item, and a store is generated. In the case of a local variable stored in the busy register, the local variable may already be stored in memory. If the local variable is currently stored in memory, then a store operation need not be performed.

At the end of generating a single target machine instruction from an intermediate language instruction, registers used for that target instruction are removed from the used-in-current-operation subclass. Busy registers known not to hold quantities required for the generation of later target machine instructions resulting from translating the intermediate language instruction are removed from the busy subclass (unmarked as busy) and added to the live subclass (i.e., marked as live). The process is repeated for each target machine instruction that must be produced in the translation of said intermediate language instruction.

At the end of translating the intermediate language instruction into machine language instructions, all registers which had been marked as busy during the translation of the intermediate language instruction are made non-busy, and are put into the live set.

Translation of Java bytecode proceeds one basic block at a time. A special table (i.e., a basic block table) may be created with one entry per basic block. Each entry includes the size of the stack on entry to the basic block, and the location of each of the stored stack items. In the case of the first basic block, the prologue has already placed certain local variables (and parameters) into registers, and indicated in the basic block table that the Java stack is empty. At the conclusion of translating a basic block, the basic block table for all successors (e.g., other basic blocks that logically can execute immediately after the translated block) are examined.

If a successor basic block S has never before been examined, we indicate in the basic block table for S, the size of the Java stack when control will reach S, and where the Java stack items are located. Most often, these locations are real registers in the target machine. In the case that some of the stack items had been spilled, then the basic block table for S must indicate where the spilled items are in storage.

If a successor basic block S has previously been examined, then its basic block table entry indicates where S expects to find its java stack items. If these stack items are not in the correct locations at the end of translation of the current basic block, then code must be generated to copy stack information from its location at the end of the current block to where the successor block S will expect it to be. Such code is commonly called compensation code. Techniques for generating compensation code are well known to those skilled in the art.

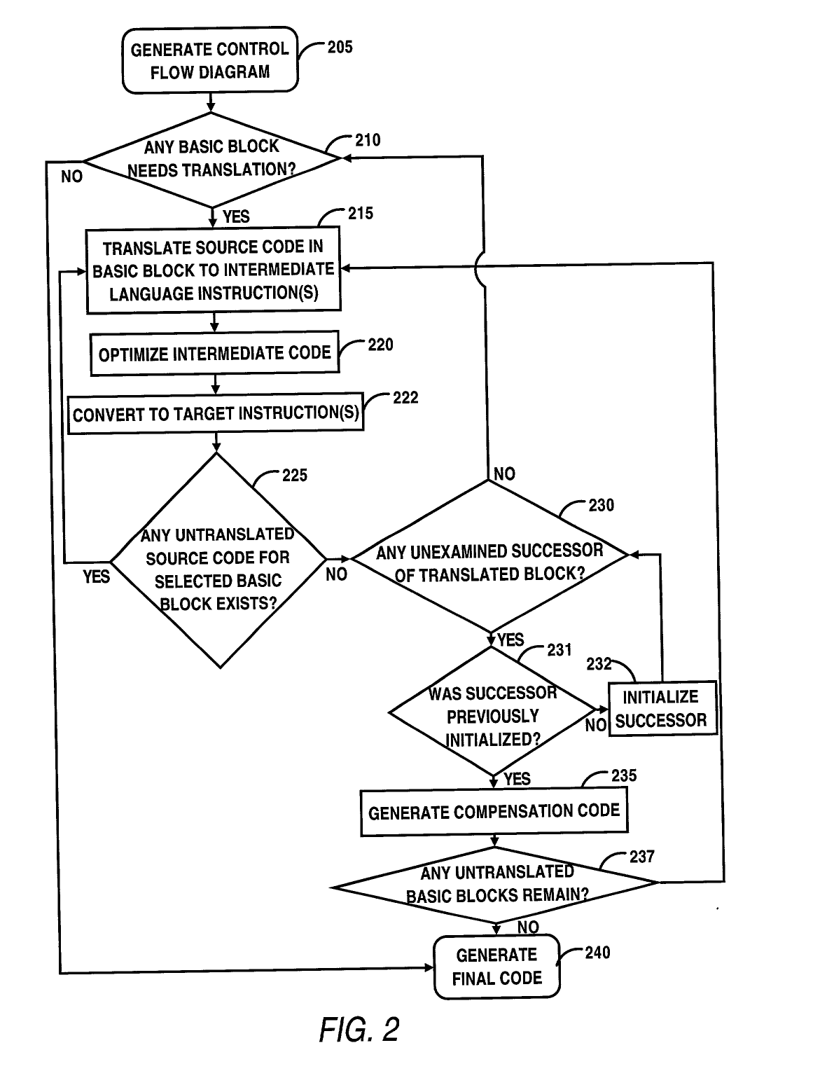

FIG. 2 illustrates an embodiment of an exemplary method 200 for compiling code using, for example, the compiler 100. In step 205, the entire source code is analyzed to generate a control flow graph. The control flow graph includes basic blocks of the source code and how each basic block is linked to other basic blocks in the source code.

In step 210, a determination is made as to whether any basic blocks need translation. If a basic block needs translation, that basic block is selected. For purposes of describing the method 200, the selected block is referred to as selected block B. A block is selected if one of its predecessors had previously been translated. If no such block exists, then a block with no predecessors is selected. A block without predecessors is called an entry node. From the basic block table, the allocation of stack items on entry to the selected block B is read and is used to initialize the state of the stack allocations. Entry nodes have an empty list of stack allocations. If no untranslated basic block B is found, control goes to step 240.

In step 215, the first remaining untranslated portion of source code in the basic block B is translated into intermediate language instruction(s). In the Java context, this is a single Java Virtual Machine byte-code. For each intermediate operation generated, real registers are allocated for the operands.

In step 220, optimization, such as redundant code elimination and constant propagation are performed for translated intermediate language instructions. In step 222, the intermediate language instructions are converted into target instructions. Additional register allocation may be needed if a single intermediate level instruction expands into more than one target level instruction.

In step 225, the basic block B is examined for additional untranslated source code. If such untranslated code exists, control returns to step 215.

In step 230, the basic block table entries for all the successors of the basic block B are examined to determine whether a successor (e.g., S) to the basic block B has not been examined. If all the succesors have been examined, control returns to step 210. If an unexamined successor S has been identified, a determination is made as to whether the successor S has been previously initialized (step 231). If the successor S has not been previously initialized, then the successor S is initialized (step 232), and control continues to step 230. During initizialization, the final allocation of stack items for B becomes the initial allocation of stack items for S, and the basic block entry for S is initialized to reflect this allocation.

If the successor S already has an allocation indicated in its basic block table entry (i.e., the successor S was previously examined), then compensation code is generated to place the stack items in the registers and/or memory locations expected by basic block S (step 235).

In step 237, if any untranslated basic blocks remain, control returns to step 210. For example, a determination is made as to whether any other basic blocks of source code need to be translated. If another basic block needs to be translated, then that basic block is translated in step 215. When control reaches step 240, the entire source code has been translated into an internal representation of the target machine code. The final code (i.e., machine readable code) is generated from the internal representation of target code using the allocated real registers.

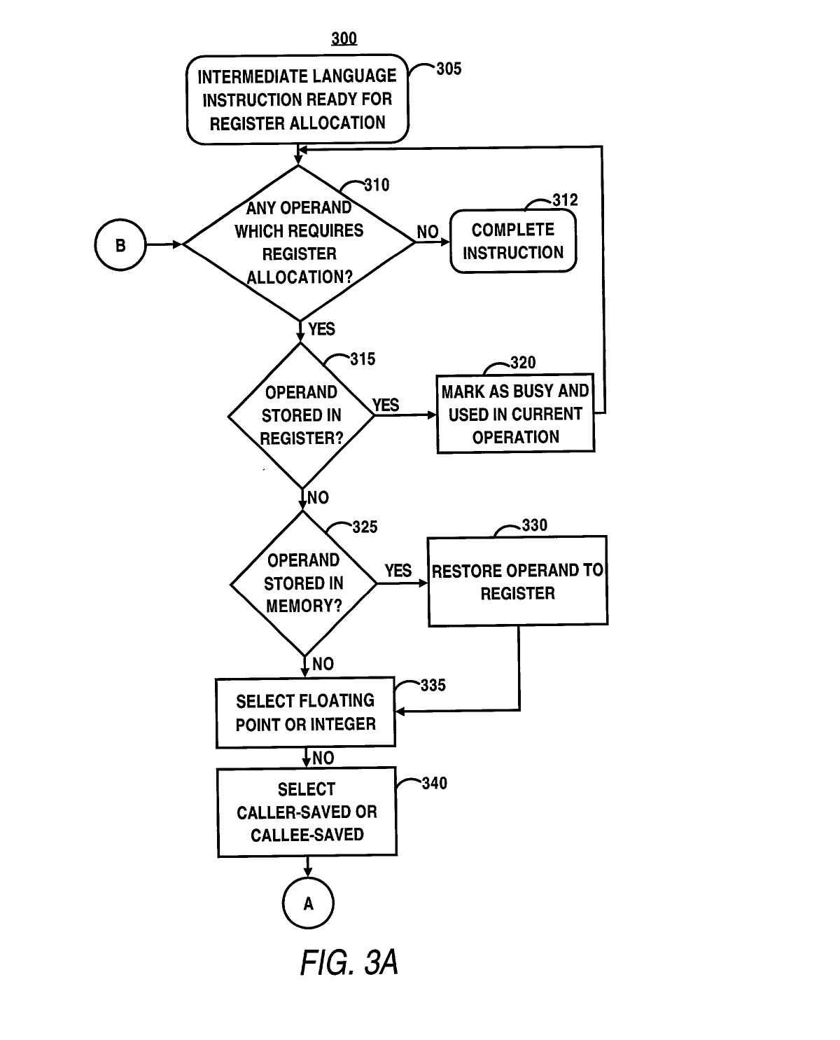

FIGS. 3A-3B illustrate an embodiment of an exemplary method 300 for performing register allocation according to the present invention. This method includes steps that may be performed in steps 215, 220 and 222, shown in FIG. 2.

In step 305, an intermediate language instruction is ready for register allocation (similarly to step 215, shown in FIG. 2).

In step 310, a determination is made as to whether an operand from the intermediate language instruction requires register allocation. If no operands for the intermediate language instruction needs allocation (e.g., all the operands have been allocated), all allocation for the intermediate language instruction is complete (step 312). Then, the intermediate level instruction can be rewritten as one or more target instructions (in an intermediate representation) using real registers.

If an operand needs allocation, the compiler 100 determines whether the operand is already stored in a register (step 315). For example, a table T is updated with information showing which operandis stored in each real register. The table is analyzed to determine whether the operand is currently stored in a register.

In step 320, if the operand is currently stored in a register, then the register is marked as busy and used-in-current-operation, such that the register holding the operand may not be overwritten with new data in the register. Control then returns to step 310.

In step 325, the compiler 100 determines whether the operand is stored in memory if the operand is not stored in a register. For example, a table T is maintained that includes information regarding data (e.g., contents of spilled registers) stored in memory. This table is analyzed to determine whether the operand is stored in memory.

In step 330, if the operand is stored in memory, the operand is restored to a register. The register to which the operand is restored to is selected in the subsequent steps.

In the subsequent steps 335-340 and steps 342-362, shown in FIG. 3B, a register is selected for storing the operand. In step 335, a floating point or an integer register is selected depending on the type of data being stored in the register. Floating point values are stored in floating point registers and integer values are stored in integer registers. If all the registers are of one type (e.g., a processor only supports integer registers), then this step may be omitted.

In step 340, a callee-saved or caller-saved register is selected (i.e., a register from the callee-saved class or the caller-saved class is selected). Callee-saved registers are preferably used to store local variables, stack items and parameters input by a user (since these will be preserved over method invocations). Caller-saved registers are preferably used to store temporary computations, except for those which are known to be live over any method calls. A heuristic process may be used to determine whether the data is should be stored in a callee-saved or caller-saved register. For example, the compiler 100 may store temporary computations in the caller-saved registers, because the temporary computations are needed for a limited period of time. A library routine may store a temporary computation in a caller-saved register. Local variables and stack items, which are generally needed for a longer period of time, are stored in callee-saved registers.

Steps 342-362 are shown in FIG. 3B. In step 342, the compiler 100 identifies all registers (e.g., register set S) which are not in used-in-current-operation and in the class selected (i.e., caller-saved or callee-saved) in step 340. If the set S is empty, step 346 is performed. Otherwise, another class may be selected for allocation at step 344.

In step 346, the compiler 100 determines whether a register (e.g., a register R) in the register set S is not in any of the busy, live, and used sets. If such a register R is identified, then it is selected. Then, the register R is assigned to the operand (step 350). If no such register R is found, the step 348 is performed.

In step 348, the compiler 100 determines whether any register R in the register set S is not in the sets busy and live, but is a member of the used set. If such a register R is identified, then it is selected, and the register is assigned to the operand (step 350). If no such register R is found, step 352 is performed.

In step 352, the compiler 100 determines whether there is a register R in the register set S which is live and not busy. If a live register R is available, table T (described with respect to step 325) is modified to remove the correspondence between R and the operand that it represented. Then, R is assigned to the operand (step 350). If no such register R is found, step 356 is performed.

In step 356, the compiler 100 determines whether a busy register R is a member of S. If such a register is found, then its contents are spilled, and the table T is modified to show that the operand which was in register R is now in the memory location selected to contain the spilled operand. Then, the register R is assigned to the operand (step 350). If a busy register is not found in step 356, then a register from another class is selected (step 344).

In step 360, the selected register R is placed in the sets busy and used-in-current-operation. If the operand is a source operand to the instruction, code is generated to load R with the operand data. The table T is modified to show that the operand is in register R, and that R holds the operand. Then, control returns to step 310.

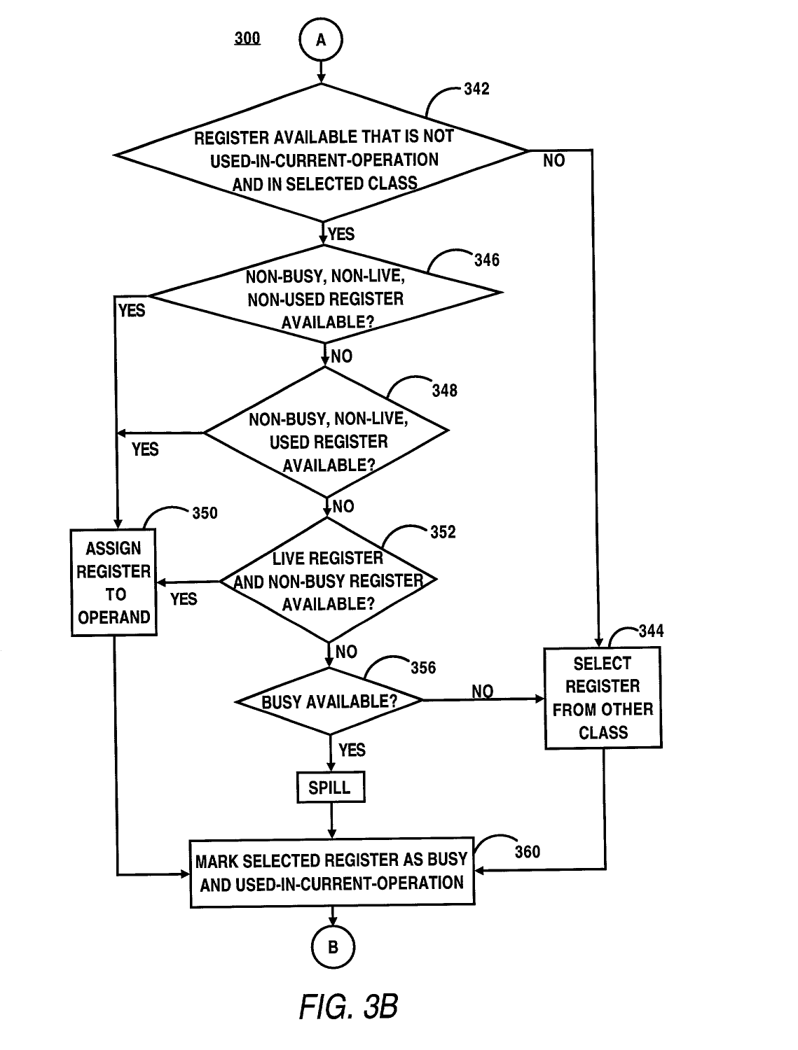

FIG. 4 illustrates an embodiment of an exemplary computer system 400 employing principles of the present invention. The computer system 400 includes a bus 402 or other communication mechanism for communicating information, and a processor 404 coupled with the bus 402 for processing information. The processor 402 is configured to run the compiler 100, shown in FIG. 1, and includes real registers 403 for allocation, such as performed by the method 300, shown in FIG. 3. The computer system 400 also includes a main memory 406, such as a random access memory (RAM) or other dynamic storage device, coupled to the bus 402 for storing information and instructions to be executed by the processor 404. The main memory 406 also may be used for storing temporary variables, spilled operands, tables, which, for example, may be used to determine what information is spilled, and other intermediate information during execution of instructions by processor 404. The computer system 400 also includes a read only memory (ROM) 408 or other static storage device coupled to the bus 402 for storing static information and instructions for the processor 404. A storage device 410, such as a magnetic disk or optical disk, is also provide and coupled to the bus 402 for storing information and instructions. The computer system 400 may include one or more conventional input devices 412 (e.g., keyboard, mouse, and the like) and a display 414. The computer system 404 may be connected to a network (not shown) through a conventional network interface (not shown).

The method 300 may further include steps for scanning basic blocks in the reverse direction, such that data may be collected as to when temporary computations are still live. Such data would allow a more effective heuristic in selecting registers to re-use from the live set, without changing the time or space complexity of our invention.

While this invention has been described in conjunction with the specific embodiments thereof, it is evident that many alternatives, modifications and variations will be apparent to those skilled in the art. There are changes that may be made without departing from the spirit and scope of the invention.

What is claimed is:

1. A method of allocating registers when compiling source code, said method comprising steps of:
translating source code to intermediate code;
identifying an operand from said intermediate code to store in a real register; and
selecting a class of real registers operable to store said operand.

2. The method of claim 1, further comprising steps of:
selecting at least one subclass of said selected class of real registers, wherein said at least one subclass includes a register to store said operand.

3. The method of claim 1, wherein said selected class includes one of a callee-saved class and a caller-saved class.

4. The method of claim 2, wherein said step of selecting at least one subclass further comprises steps of:
selecting a first set of subclasses within said selected class;
determining whether a register included in said first set of subclasses is available to store said operand; and
in response to said register being available, storing said operand in said register.

5. The method of claim 4, wherein said first set of subclasses includes at least one of non-used-in-current-operation, non-busy, non-live and non-used subclasses.

6. The method of claim 4, wherein said step of selecting at least one subclass further comprises steps of:
selecting a second set of subclasses within said selected class in response to said register not being available in said first set of subclasses;
determining whether a register included in said second set of subclasses is available to store said operand; and
in response to said register in said second set of subclasses being available, storing said operand in said register in said second set of subclasses.

7. The method of claim 6, wherein said second set of subclasses includes at least one of non-used-in-current-operation, non-busy, non-live and used subclasses.

8. The method of claim 6, wherein said step of selecting at least one subclass further comprises steps of:
selecting a third set of subclasses within said selected class in response to a register in said second set of subclasses not being available;
determining whether a register included in said third set of subclasses is available to store said operand; and
in response to said register in said third set of subclasses being available, storing said operand in said register in said third set of subclasses.

9. The method of claim 8, wherein said third set of subclasses includes at least one of non-used-in-current-operation, live and non-busy subclasses.

10. The method of claim 8, wherein said step of selecting at least one subclass further comprises steps of:
selecting a fourth set of subclasses within said selected class in response to a register in said third set of subclasses not being available;
determining whether a register included in said fourth set of subclasses is available to store said operand; and
in response to said register in said fourth set of subclasses being available, storing said operand in said register in said fourth set of subclasses.

11. The method of claim 10, wherein said fourth set of subclasses includes at least one of non-used in current operation and busy subclasses.

12. The method of claim 11, further comprising spilling a register in at least one of said busy and said live subclasses prior to storing said operand in said register in at least one of said busy and said live subclasses.

13. The method of claim 11, further comprising storing said operand in a class other than selected class in response to a register in said fourth set of subclasses not being available.

14. The method of claim 11, further comprising marking said register as used-in-current-operation in response to storing said operand in said register.

15. The method of claim 11, further comprising marking said register storing said operand as live and not-used-in-current-operation in response to translating an instruction of said source code.

16. The method of claim 1, further comprising steps of:
selecting another class of registers in response to said selected class of registers not including a not used in current operation register; and
storing said operand in a register in said selected other class.

17. The method of claim 3, wherein said step of selecting a class further comprises steps of:
selecting said callee-saved class in response to said operand including at least one of local variables, stack items and parameters input by a user; and
selecting said caller-saved class in response to said operand including a temporary computation.

18. A method of compiling source code comprising steps of:
generating intermediate code from a portion of source code;
allocating a plurality of real registers to store a plurality of operands from said intermediate code while generating the intermediate code; and
generating machine-readable code from said intermediate code using said plurality of real registers.

19. The method of claim 18, further comprising a plurality of types of operands and said step of allocating further comprises steps of:
determining a type of operand for at least one of said plurality of operands;
storing said at least one operand in memory in response to said operand being a particular type of operand; and
allocating a real register for said operand.

20. The method of claim 19, wherein said particular type of operand includes a local variable.

21. The method of claim 19, wherein said step of allocating further comprises steps of:
selecting a class of registers depending on said type of operand; and
allocating a real register from said selected class of registers depending on said type of operand.

22. The method of claim 21, wherein said step of selecting a class further comprises steps of:
selecting a first class of registers in response to said operand being at least one of a local variable, a stack item and a parameter input by a user; and
selecting a second class of registers in response to said operand being a temporary computation.

23. The method of claim 21, wherein said step of selecting allocating further comprises selecting at least one subclass of registers in said selected class.

24. The method of claim 23, wherein said at least one selected subclass includes at least one of live registers, non-live registers, busy registers, non-busy registers, used registers, non-used registers, and non-used in current operation registers.

25. A compiler configured to compile source code into machine-readable code, said compiler comprising:
a register allocation stage configured to generate intermediate code from said source code and configured to allocate a plurality of real registers to a plurality of operands from said intermediate code;
an optimization stage configured to optimize said intermediate code; and
a final code stage configured to generate said machine-readable code from said intermediate code using said plurality real registers.

26. The compiler of claim 25, wherein said register allocation stage is configured to determine a type of operand for at least one of said plurality of operands, and store said at least one operand in memory in response to said operand being a particular type of operand, and allocate a real register for said operand.

27. The compiler of claim 26, wherein said particular type of operand includes a local variable.

28. The compiler of claim 25, wherein said register allocation stage is further configured to select a class of registers and allocate a real register from said selected class of registers for one of said plurality of operands, said one operand being of a particular type of operand.

29. The compiler of claim 28, wherein said register allocation stage is further configured to select a first class of registers in response to said operand being a type including at least one of a local variable, a stack item and a parameter input by a user; and
select a second class of registers in response to said operand being a temporary computation.

30. The compiler of claim 28, wherein said register allocation stage is further configured to select at least one subclass of registers in said selected class.

31. The compiler of claim 30, wherein said at least one selected subclass includes at least one of live registers, non-live registers, busy registers, non-busy registers, used registers, non-used registers, and non-used in current operation registers.
